(19) United States
(12) Patent Application Publication
(10) Pub. No.: US 2008/0005970 A1
(43) Pub. Date: Jan. 10, 2008

(54) Casement Operator with Movable Cover

(75) Inventors: Raymond E. Hufnagle, Orlando, FL (US); Robert Munin, Media, PA (US); She Shun Zhang, Shanghai (CN)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: ULTRA HARDWARE PRODUCTS LLC, Pennsauken, NJ (US)

(21) Appl. No.: 11/774,623

(22) Filed: Jul. 9, 2007

Related U.S. Application Data
(60) Provisional application No. 60/819,022, filed on Jul. 7, 2006.

(51) Int. Cl. E05F 11/10

(52) U.S. Cl. 49/279

(57) ABSTRACT

A casement operator for opening and closing a window includes a housing, a cover and a crank assembly. The cover is moveable between a closed position and an open position. The crank assembly is pivotable and includes a crank handle and a gear mounted to the crank handle. The crank handle is pivotable between a retracted position and an extended position. The crank handle is enclosed within a storage cavity in a storage position. The crank handle includes a bore proximate a base end and the gear has a first detent and a second detent. A biasing member is mounted within the bore and a securing plug is mounted at least partially within the bore. The biasing member biases the securing plug toward the gear such that the securing plug is located in the first detent in the retracted position and in the second detent in the extended position.

### CROSS-REFERENCE TO RELATED APPLICATIONS

This application claims the benefit of U.S. Provisional Patent Application No. 60/819,022, which was filed Jul. 7, 2006, is entitled “Casement Window Operator with Exchangeable Cover and Pre-Assembled Crank Handle” and is incorporated herein by reference in its entirety.

### BACKGROUND OF THE INVENTION

Casement window operators have traditionally featured a handle that protrudes from an operator assembly to allow the handle to be cranked or rotated to open and close a window. Such handles have previously protruded from the window or, more recently, been collapsible. Such traditional designs and even the more recent collapsible designs are typically not aesthetically pleasing, interfere with some window covering installations and often include surfaces that are prone to dust collection. Specifically, these casement operators typically have grooves or uneven surfaces proximate the crank handle or in other portions of the casement window operator housing where dust and dirt may accumulate. These grooves and uneven surfaces are also considered unattractive by many consumers.

A handle protruding or exposed from a window and from a casement operator is typically not aesthetically pleasing to consumers, particularly if the handle or associated hardware clashes with the overall interior design of the room, and is typically difficult to clean. These problems are of personal preference and general ease of cleaning. In addition, design and practical concerns relating to the traditional and more recent casement operators include the difficulty of changing the appearance, for example, by repainting a casement operator assembly to match the decor of a room, which is difficult to do with the complex shapes of the traditional and more modern casement operators and, once installed, such complex-shaped casement operators and handles are difficult to adapt to changes in room decor, such as a change in color. Such situations are undesirable to consumers.

With many known window covering installations, particularly designs where the window covering pulls down over the window, a protruding handle may generate inconveniences. For example, a protruding handle often leads to scenarios where the window operator gets in the way of the window covering, causing the window covering to either get caught on the handle or form an unsightly bulge in the window covering. That is, in a closed or hanging position, the window covering interferes with the casement operator or its crank handle creating an unsightly bulge in the covering. The handle may even damage the window covering in certain situations. Many consumers find these features of the casement operator undesirable.

Certain, more modern casement operators may be collapsible to reduce occurrences of interference with a window hanging. These more modern, collapsible casement operators often have cleanliness drawbacks. The nested handle design of some known window casement operators leads to scenarios where dust and dirt collects in the nested edges of the housing. These nested edges are also often considered unsightly by consumers.

Given these drawbacks and undesirable side-effects on window coverings of traditional casement window operators, a solution is needed that will address these issues and more. The casement window operator with movable cover is designed and constructed to address the above-described issues of traditional or even more modern nestable window casement operators as well as to provide improvements in the field.

### BRIEF SUMMARY OF THE INVENTION

Briefly stated, the present application is directed to a casement operator for opening and closing a window including a housing, a cover moveably mounted to the housing and a crank assembly mounted to the housing. The cover is movable between a closed position and an open position. The cover and housing define a storage cavity when the cover is in the closed position. The crank assembly includes a crank handle and a gear mounted to the crank handle. The crank handle is pivotable relative to the gear. The crank handle and the gear are rotatable about an operation axis relative to the housing. The crank handle is movable between a retracted position and an extended position relative to the gear. The crank handle is enclosed within the storage cavity in a storage configuration.

In another aspect, the present application is directed to a casement operator for manipulating a window including a housing, a cover moveably mounted to the housing, a crank handle mounted to the housing, a gear rotatably mounted to the housing, a biasing member and a securing plug. The crank handle is pivotable between a retracted position and an extended position relative to the housing. The crank handle has a grasping end, a base end, a bore proximate the base end and a longitudinal axis. The gear includes a first detent and a second detent. The biasing member is mounted within the bore and the securing plug is mounted at least partially within the bore. The biasing member biases the securing plug toward the gear along the longitudinal axis. The securing plug is located in the first detent when the crank handle is in the retraced position and is located in the second detent when the crank handle is in the extended position to releasably secure the crank handle in the retracted position or the extended position.

### BRIEF DESCRIPTION OF THE SEVERAL VIEWS OF THE DRAWINGS

The foregoing summary, as well as the following detailed description of preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a front perspective view of a casement operator mounted to a window frame, showing a cover in a closed position;

FIG. 2 is a top perspective view of the casement operator shown in FIG. 1, showing the cover in an open position;

FIG. 3 is a partially exploded view of the casement operator shown in FIG. 1;

FIG. 4A is a top perspective view of a housing of the casement operator shown in FIG. 1;

FIG. 4B is a right-side elevational view of the housing shown in FIG. 4A;

FIG. 5 is a top perspective, partially exploded view of a portion of a crank assembly of the casement operator shown in FIG. 1;

FIG. 5A is a front elevational view of a gear of the casement operator shown in FIG. 1;

FIG. 6 is a bottom perspective, partially exploded view of the casement operator shown in FIG. 1; and

FIG. 7 is a top plan view of the casement operator shown in FIG. 1, showing the cover in the open position and a crank handle in an extended position.

### DETAILED DESCRIPTION OF THE INVENTION

Certain terminology is used in the following description for convenience only and is not limiting. The words “right”, “left”, “lower” and “upper” designate directions toward and way from, respectively, the geometric center of the casement operator and designated parts thereof. The terminology includes the above-listed words, derivatives thereof and words of similar import.

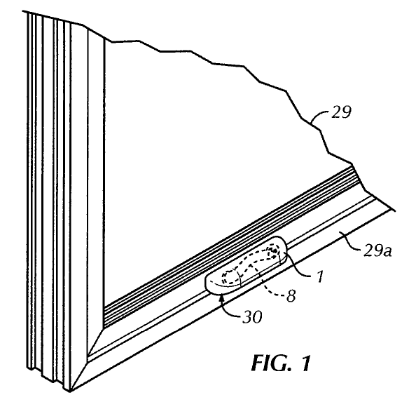

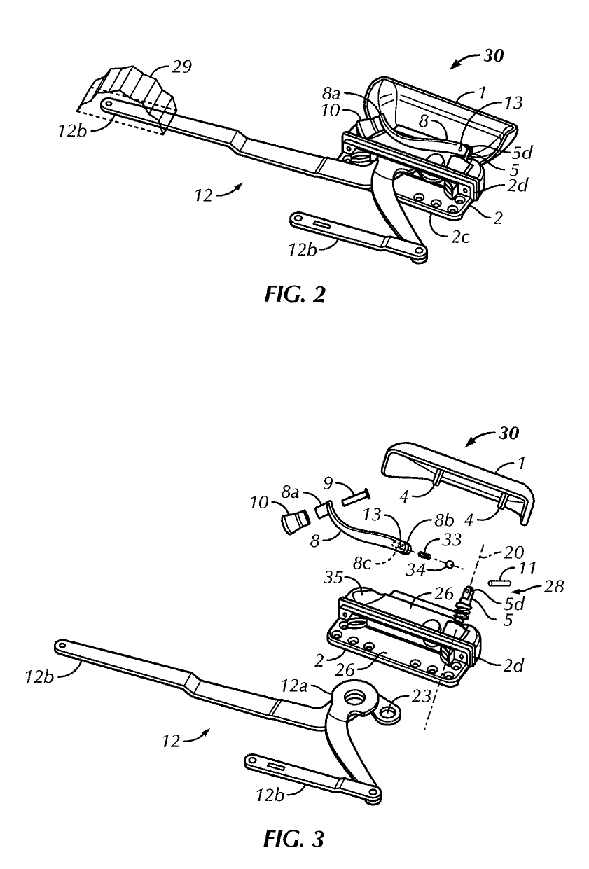

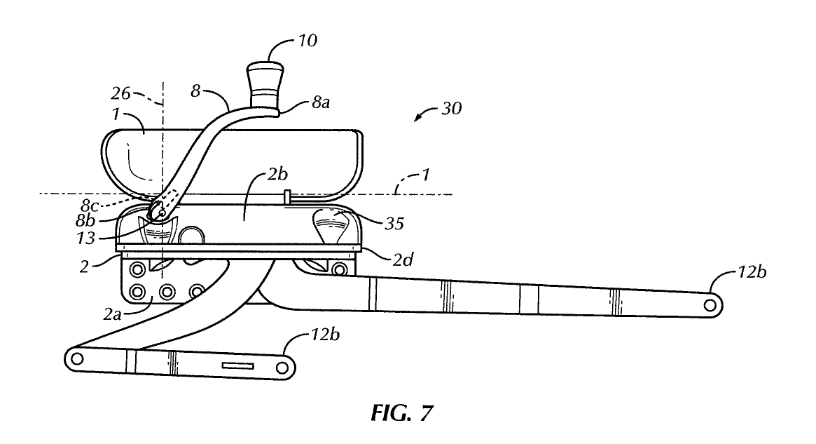

Referring to FIGS. 1-4B and 7, a casement operator, generally designated 30, is utilized to open and close a window 29. The casement operator 30 includes a housing 2, a cover 1 moveably mounted to the housing 2 and a crank assembly 28 mounted to the housing 2. In the preferred embodiment, the cover 1 is pivotably mounted to the housing 2 about a door axis 1a to and between a closed position (FIG. 1) and an open position (FIGS. 2 and 7).

The cover 1 preferably includes a pair of inverted hemispheres 4 located on an inside surface and the housing 2 preferably includes a pair of protruding hemispheres 3 located on an external surface. The inverted hemispheres 4 and protruding hemispheres 3 are located on the door axis 1a in the assembled configuration. The inverted hemispheres 4 receive the protruding hemispheres 3 therein such that the door 1 is pivotable about the door axis 1a to selectively cover or expose at least a portion of the housing 2. The cover 1 is not limited to inclusion of the inverted hemispheres 4 and the housing 2 is not limited to inclusion of the protruding hemispheres 3 to rotatably mount the cover 1 to the housing 2. For example, the cover 1 may be hingedly mounted or otherwise pivotably mounted to the housing 2 in nearly any manner, utilizing nearly any structure that permits pivotable movement of the cover 1 relative to the housing 2 and such pivotable constructions are generally apparent to one having ordinary skill in the art. In addition, the cover 1 is not limited to being pivotable relative to the housing 2 and may be slidable or otherwise movable relative to the housing 2.

Referring to FIGS. 1-3 and 7, in the preferred embodiment, the cover 1 generally encompasses a portion of the housing 2 and hardware of the casement operator 30 in the closed position, at least the portion of the housing 2 that is typically viewed by a user at the top and side surfaces, which extend from a window frame 29a. The external surface of the cover 1 is preferably, generally smooth and continuous to create a generally smooth, continuous appearance of the casement operator 30 in the closed position when mounted to the window 29 and the window frame 29a. The generally smooth, continuous surface of the cover 1 creates a generally smooth, clean, aesthetically pleasing appearance of the casement operator 30 in the closed position. In addition, the generally smooth, continuous external surface of the cover 1 is preferably conducive to painting or alternative aesthetic appearance modification such that the color or general aesthetic appearance of the external surface of the cover 1 and, therefore, the casement operator 30, may be readily modified by a user. Further, in the closed position, the cover 1 is positioned in generally close proximity to the housing 2 such that the casement window operator 30 has a relatively low profile. Accordingly, the casement window operator 30 preferably does not interfere with a window treatment or covering (not shown) that is typically associated with the window 29.

The cover 1 may include a lock (not shown) for locking the cover 1 to the housing 2 in the closed position. The ability to lock the cover 1 in the closed position may be employed for security reasons in a home or a commercial setting (hotel). The lock may be of nearly any type that permits locking of the cover 1 to the housing 2 in the closed position and is typically of the type that is well known to one having ordinary skill in the art. The casement operator 30 is not limited to the inclusion of the lock, but may include the lock for safety or security reasons, as would be apparent to one having ordinary skill in the art upon reviewing the present disclosure. Accordingly, in a hotel environment, the cover 1 may be locked to the housing 2 in the closed position to prevent guests from opening or otherwise manipulating the window 29 for safety or security reasons.

Referring to FIGS. 1-3 and 4B, the cover 1 and the housing 2 define a storage cavity 27 when the cover 1 is in the closed position. The storage cavity 27 is defined by an inner surface of the cover 1 and a portion of an external surface of the housing 2 proximate the crank assembly 28. In the preferred embodiment, the crank assembly 28 is enclosed or covered by the cover 1 and is at least partially located in the storage cavity 27 when the cover 1 is in the closed position. The crank assembly 28 and a portion of the housing 2 is preferably enclosed or covered by the cover 1 to improve the aesthetic appearance of the casement operator 30 and generally limits the accumulation of dust and/or dirt on the crank assembly 28 and the housing 2. Further, the protection of the crank assembly 28 through location in the storage cavity 27 may also limit exposure of the moving parts of the crank assembly 28 to dust and/or dirt exposure, thereby improving performance and/or durability of the crank assembly 28.

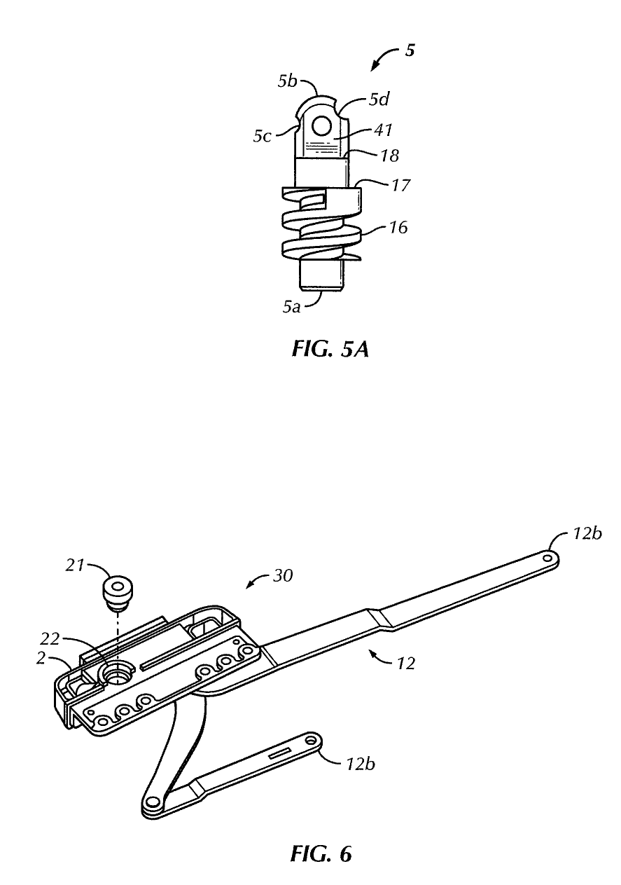

Referring to FIGS. 2, 3 and 5-7, the crank assembly 28 includes a crank handle 8 and a gear 5 mounted to the crank handle 8. The crank handle 8 is pivotable relative to the gear 5 about a handle axis 25. The crank handle 8 and the gear 5 are rotatable about an operation axis 26 relative to the housing 2. The crank handle 8 is moveable between a retracted position (FIG. 2) and an extended position (FIG. 7) relative to the gear 5 about the handle axis 25. The crank assembly 28 also preferably includes a threaded arm center screw 21 (FIG. 6).

In the preferred embodiment, the gear 5 is comprised of a worm gear 5 constructed of a tempered steel and includes a standard worm gear spiral thread 16. A spring (not shown) is preferably placed on a flat shoulder edge 17 and a fixing screw (not shown) is preferably placed on top of the spring in an assembled configuration. The worm gear 5 preferably includes a gear end 5a and a handle end 5b. The gear end 5a of the worm gear 5 rotatably connects to the housing 2 for rotation of the worm gear 5 about the operation axis 26. The handle end 5b of the worm gear 5 preferably includes an opening 19 in flat faces 41 to permit a fastener 11 to pivotably connect the crank handle 8 to the worm gear 5. A flat edge 18 is located on the worm gear 5 proximate the flat faces 41 and preferably meets the flat shoulder edge 17. The worm gear 5 is preferably threaded in a slot 2a in the housing 2 within which the gear end 5a rotates in the assembled configuration.

Referring to FIGS. 3, 5 and 7, the crank handle 8 preferably has a curved-shape between a grasping end 8a and a base end 8b. Holes 13 are preferably formed in the base end 8b of the crank handle 8 for attaching the crank handle 8 to the worm gear 5, preferably utilizing a removable fastener 11. A rivet 9 preferably mounts a crank knob 10 to the crank handle 8 proximate the grasping end 8a. The crank knob 10 is preferably rotatable or pivotable about the rivet 9 relative to the grasping end 8a to accommodate rotation of the crank handle 8 relative to the housing 2, as would be apparent to one having ordinary skill in the art. The crank handle 8 is not limited to being mounted to the worm gear 5 or crank knob 10 using the removable fastener 11 or the rivet 9, respectively, and may be mounted to the worm gear 5 and crank knob 10 in nearly any matter that is able to withstand the normal operating conditions of these components and perform the typical functions of these components. When attached to the worm gear 5 via the fastener 11, the crank handle 8 is rotatable about the operation axis 26 of the worm gear 5. The fastener 11 may alternatively be comprised of a screw, a rivet or nearly any fastener that secures the handle 8 to the gear 5. It is preferred that the fastener 11 is comprised of a screw or other removable fastener that permits removal and replacement of the crank handle 8 from the worm gear 5 if, for example, the crank handle 8 is damaged or broken such that the crank handle 8 may be removed and replaced.

Referring to FIGS. 2, 3, 5A and 7, in the preferred embodiment, the worm gear 5 drives an arm 12 which is attached to the window 29 and operates in a manner that is generally well known to those having ordinary skill in the art. Thus, by turning the crank handle 8 and worm gear 5 about the operation axis 26, a user can open and close the window 29. The fastener 11 allows the crank handle 8 to pivot about a handle axis 25 and to be removably mounted to the worm gear 5. The crank handle 8 is not limited to being pivotably mounted by the first fastener 11 about the handle axis 25 or to being removably mounted to the worm gear 5. For example, the crank handle 8 may be permanently secured to the worm gear 5 and fixed in the extended position such that the crank handle 8 may be operated to rotate the worm gear 5 about the operation axis 26 for opening and closing the window 29. The fastener 11 preferably permits the crank handle 8 to be moved from the extended to the retracted position, wherein the crank handle 8 is positioned in proximity to the housing 2.

Referring to FIGS. 3-6, the crank assembly 28 includes the adjustable threaded arm center screw 21 that is mounted in a threaded hole 22 in the housing 2. The screw 21 preferably fits into a slot 23 in the arm 12 and secures the arm 12 to the housing 2. The screw 21 may be tightened or loosened to accommodate a variable thickness of the arm 12 to ensure a tight fit. The crank assembly 28 is not limited to inclusion of the screw 21 or to the screw 21 being adjustable. In the preferred embodiment, the screw 21 is pivotably mounted to the housing 2 and meshes with the worm gear 5. The operating arms 12 having a proximal end 12a secured to the screw 21 and a distal end 12b secured to the window 29 to drive the opening and closing of the window 29. The preferred embodiment includes the two operating arms 12 shown in the figures, but the structure is not so limited. The casement operator 30 may include a single operating arm or more than two operating arms to drive the opening and closing of the window 29.

Referring to FIGS. 1-3, 5 and 7, the crank handle 8 is pivotable about the handle axis 25 relative to the worm gear 5 between the retracted position and the extended position. In the extended position, the crank handle 8 is rotated about the operation axis 26 to open and close the window 29. In the retracted position, the crank handle 8 is positioned in close proximity to the housing 2 and is enclosed within the storage cavity 27 in a storage configuration. Covering the crank handle 8 with the cover 1 in the storage configuration generally limits exposure of the crank handle 8, the crank assembly 28 and portions of the external surface of the housing 2 to dust and dirt exposure. In addition, the storage configuration is generally aesthetically pleasing (See FIG. 1) when compared to conventional casement operators that include the crank handle, the housing and the crank assembly exposed at the window frame 29a. In addition, the cover 1 may be painted, colored or otherwise decorated to blend with the decor of a room or the window frame 29a to further enhance the aesthetic characteristics of the casement operator 30.

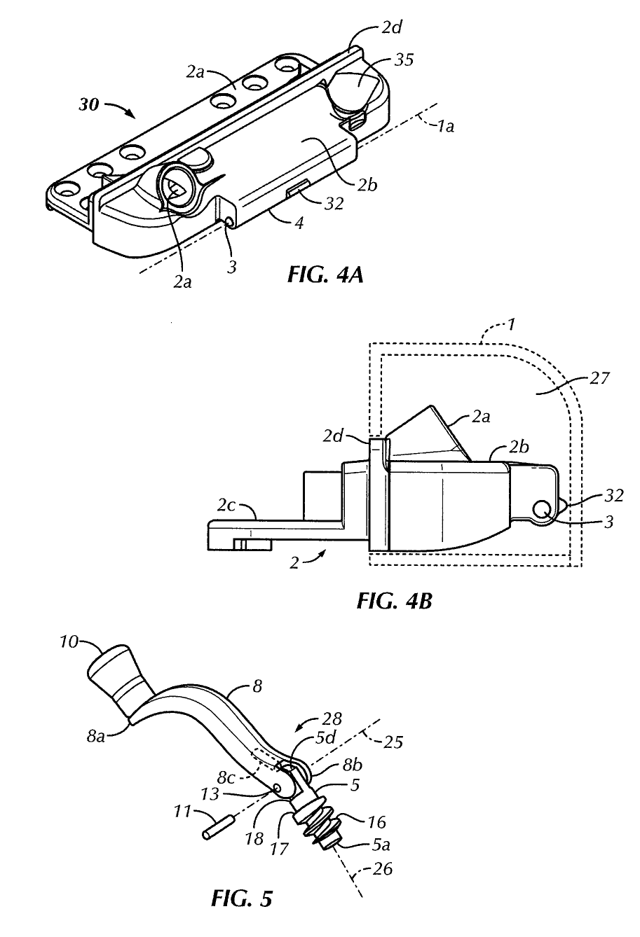

Referring to FIGS. 3-4B, in the preferred embodiment, a protrusion 32 extends from the housing 2 and interacts with the cover 1 to create an audible closing sound when the cover 1 moves into the closed position. Specifically, when the cover 1 moves to the closed position, an audible sound, preferably a click sound, indicates to the user that the cover 1 has moved to the closed position. The housing 2 is not limited to inclusion of the protrusion 32 or to the protrusion 32 interacting with the cover 1 to create the audible sound when the cover 1 moves to the closed position. For example, the cover 1 may include a protrusion or other feature that interacts with the housing 2 to create the clicking sound, an alternative feature may be included in the casement operator 30 to provide an audible sound when the cover 1 moves to the closed position or no clicking sound may be created by any feature on the cover 1 or housing 2. However, the clicking sound is preferred to provide an indication to the user that the cover 1 is located in the closed position and, potentially, to releasably secure the cover 1 in the closed position such that a positive force must be applied to the cover 1 to move the cover 1 out of the closed position.

Referring to FIGS. 1-7, in the preferred embodiment, the protruding hemispheres 3 and inverted hemispheres 4 are located on the cover 1 and housing 2 at a position generally distanced from the window frame 29a and window 29. Accordingly, the door axis 1a is preferably oriented generally parallel to and distanced from the window 29. This arrangement results in the cover 1 pivoting away from the window 29 from the closed position to the open position. The door axis 1a is not limited to being distanced from the window 29 or to being generally parallel relative to the window 29 and may be located relatively proximate to the window 29 or may be perpendicular or otherwise angled relative to the window 29, as long as the door axis 1a accommodates movement of the cover 1 from the closed position to the open position to expose the crank handle 8 for manipulation by a user. In addition, the cover 1 is not limited to being pivotable about the door axis 1a and may be slideable relative to the housing 2 or alternatively mounted to selectively cover and expose the crank handle 8. In addition, the mounting of the cover 1 to the housing 2 utilizing the protruding hemispheres 3 and inverted hemispheres 4 permit removal and replacement of the cover 1 relative to the housing 2 such that the aesthetic appearance of the casement window operator 30 may be easily and quickly modified.

Referring to FIGS. 2, 3, 5 and 5A, in the preferred embodiment, the casement operator 30 also includes a biasing member 33 mounted within a bore 8c in the crank handle 8 and a securing plug 34 mounted at least partially within the bore 8c. The bore 8c is preferably defined at the gear end 8a of the crank handle 8 and is comprised of a blind bore positioned along a longitudinal axis of the crank handle 8. The bore 8a preferably includes a closed end and a mouth that opens at the base end 8b. The biasing member 33 is preferably in facing engagement with the closed end of the bore 8c and biases the securing plug 34 away from the closed end and at least partially out of the mouth of the bore 8c. The casement operator 30 is not limited to inclusion of the biasing member 33 or the securing plug 34, however, these components are preferred for releasably securing the crank handle 8 in the extended and retracted positions, as will be described in greater detail below.

The gear 5 preferably includes a first detent 5c and a second detent 5d, which are both located at a peripheral edge of the gear 5 proximate the handle end 5b. The first and second detents 5c, 5d are preferably arcuate-shaped for receipt of the securing plug 34 therein. Specifically, the securing plug 34 is preferably comprised of a detent sphere 34 that is slideable in and out of the first and second detents 5c, 5d to releasably secure the crank handle 8 in the retracted or extended positions, respectively. In addition, the biasing member 33 is preferably comprised of a coil spring 33 that biases the detent sphere 34 toward the handle end 5b of the gear 5 in the assembled configuration. The coil spring 34 is preferably configured and constructed such that the detent sphere 34 may be moved in and out of the first and second detents 5c, 5d on the worm gear 5 for releasably securing the crank handle 8 in the retracted and extended position, respectively. The casement operator 30 is not limited to inclusion of the detent spring 33, the detent sphere 34 and the first and second detents 5c, 5d to releasably secure the crank handle 8 in the retracted and extended positions and may be comprised of nearly any securing mechanism, such as hook and loop material, clamps, fasteners, a set screw or other mechanisms that permit releasable securing of the crank handle 8 in the extended and retracted positions. However, the detent spring 33, detent sphere 34 and first and second detents 5c, 5d are relatively simple mechanical structures that releasably secure the crank handle 8 in the retracted and extended positions.

In the preferred embodiment, the detent sphere 34 is located in the first detent 5c when the crank handle 8 is positioned in the retracted position and is located in the second detent 5d when the crank handle 8 is positioned in the extended position. The casement operator 30 is not limited to inclusion of only the first and second detents 5c, 5d and may include several additional detents, no detents or a single detent, depending upon the preferred positions of the crank handle 8 relative to the worm gear 5 and/or the particular requirements of the casement operator 30. However, the first and second detents 5c, 5d are preferred to releasably secure the crank handle 8 in the preferred extended and retracted positions for operation of the casement operator 30 or positioning of the casement operator 30 in the storage configuration, which is generally aesthetically pleasing to users.

Referring to FIGS. 2, 3-4B and 7, in the preferred embodiment, a crank knob 10 is mounted to the grasping end 8a of the crank handle 8. The preferred housing 2 includes a knob depression 35 that is exposed to the storage cavity 27. When the crank handle 8 is in the retracted position, the crank knob 10 is located in the knob depression 35. The knob depression 35 accommodates the crank knob 10 to provide a compact and low-profile retracted position for the crank handle 8 and the crank knob 10 such that the overall size and configuration of the casement operator 30 is relatively compact and to provide support for the crank knob 10 and crank handle 8 in the retracted position. The relatively compact design of the casement operator 30 is typically preferred by a user. However, the housing 2 is not limited to inclusion of the knob depression 35 or to inclusion of the crank knob 10, as would be apparent to one having ordinary skill in the art.

Referring to FIGS. 4A and 4B, in the preferred embodiment, the housing 2 includes a plateau 2b, a mounting flange 2c and a separating wall 2d extending generally parallel to a window plane of the window 29 between the plateau 2b and the mounting flange 2c. The crank handle 8 is preferably in facing engagement with the plateau 2b in the retracted position. The mounting flange 2c is preferably utilized to mount the casement operator 30 to the window frame 29a.

In the preferred embodiment, the detent sphere 34 is constructed of a metallic material but is not so limited. For example, detent sphere 34 may be constructed of a composite, wooden, polymeric or nearly any other material that is able to withstand the normal operating conditions of the detent sphere 34 and take on the general size and shape of the detent sphere 34.

Referring to FIGS. 1-7, in operation, the casement operator 30 is mounted to the window frame 29a and the window 29 to permit opening and closing of the window 29. The casement operator 30 is generally positioned in the storage configuration and may be locked to prevent a user from gaining access to the crank assembly 28. The cover 1 is subsequently pivoted about the door axis la from the closed position (FIG. 1) to the open position (FIGS. 2 and 7). The crank handle 8 or crank knob 10 is grasped by a user to move the crank handle 8 from the retracted position (FIG. 2) to the extended position (FIG. 7) by pivoting the crank handle 8 about the handle axis 25. An initial force is required to move the crank handle 8 from the retracted position to urge the detent sphere 34 out of the first detent 5c against the biasing of the coil spring 33. Accordingly, to pivot the crank handle 8 out of the retracted position, the biasing force of the coil spring 33 must be overcome to move the detent sphere 34 out of the first detent 5c and pivot the crank handle 8 about the handle axis 25. As the crank handle 8 moves from the retracted position to the extended position, the detent sphere 34 slides along the peripheral surface at the handle end 5b of the gear 5. When the crank handle 8 reaches the extended position, the detent sphere 34 slides into the second detent 5d to releasably secure the crank handle 8 in the extended position. From the extended position, the crank handle 8 and gear 5 are rotated about the operation axis 26 to drive the operation arms 12. Depending upon the direction of rotation of the crank handle 8 and the gear 5 about the operation axis 26, the operation arms 12 either move the window 29 toward opened or closed positions.

When the user has manipulated the window 29 to a desired position, the crank handle 8 is rotated to a predetermined orientation relative to the operation axis 26 and is pivoted about the handle axis 25 from the extended position to the retracted position. In the retracted position, the crank handle 8 is positioned proximate or in facing engagement with the plateau 2b and the crank knob 10 is positioned within the knob depression 35, creating a generally low profile. The cover 1 is pivoted from the opened position to the closed position about the door axis 1a to cover or hide the crank handle 8 and the crank assembly 28 in the storage cavity 27. In the closed position, the crank assembly 28 and a majority of the housing 2 are generally hidden from a user's sight by the cover 1, which preferably has an aesthetically pleasing appearance on its external surfaces. In addition, as the decor of the room changes, the appearance of the cover 1 may be modified relatively easily, for example, by painting the cover 1 or by removing and replacing the cover 1. The cover 1 also tends to protect the handle 8, the housing 2 and the crank assembly 28 from dust and dirt that is present in the room and from objects that may bump into or scratch the crank assembly 28 and housing 2. Further, if the crank handle 8 is damaged during use, the fastener 11 may be removed such that the crank handle 8 may be removed and replaced. In addition, the low profile of the casement operator 30 in the closed position limits any contact between the casement operator and the window treatment that is typically associated with the window 29.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention, as defined by the appended claims.

We claim:

1. A casement operator for opening and closing a window, comprising:
a housing;
a cover movably mounted to the housing, the cover being movable between a closed position and an open position, the cover and the housing defining a storage cavity when the cover is in the closed position; and
a crank assembly mounted to the housing, the crank assembly including a crank handle and a gear mounted to the crank handle, the crank handle being pivotable relative to the gear, the crank handle and the gear being rotatable about an operation axis relative to the housing, the crank handle movable between a retracted position and an extended position relative to the gear, the crank handle being enclosed within the storage cavity in a storage configuration.

2. The casement operator of claim 1 further comprising:
a screw pivotably mounted to the housing, the screw meshing with the gear and being pivotable about a screw axis; and
an arm having a proximal end and a distal end, the proximal end secured to the screw, the arm pivotable about the screw axis as the screw pivots about the screw axis, the distal end secured to the window.

3. The casement operator of claim 1 further comprising:
a pair of inverted hemispheres located on an inside surface of the cover; and
a pair of protruding hemispheres extending from the housing, the inverted hemispheres located on a door axis and receiving the protruding hemispheres in an assembled configuration, the cover pivotable about the door axis to and between the closed and open positions.

4. The casement operator of claim 1 wherein the door includes a generally smooth, continuous external surface, the external surface covering the housing when the cover is in the closed position.

5. The casement operator of claim 1 further comprising:
a protrusion extending from the housing, the protrusion interacting with the cover to create an audible closing sound when the cover moves into the closed position.

6. The casement operator of claim 1 further comprising:
a crank knob mounted to a grasping end of the crank handle, the crank handle including a base end opposite the grasping end, the crank handle pivotably staked to the gear along a handle axis, the crank handle pivotable about the handle axis relative to the gear to and between the retracted and extended positions, the gear and the crank handle being rotatable about the operation axis.

7. The casement operator of claim 6 further comprising:
a detent sphere; and
a detent spring, the detent sphere and detent spring mounted in a bore proximate a grasping end of the crank handle.

8. The casement operator of claim 7 wherein the gear includes a first detent and a second detent, the detent spring biasing the detent sphere away from the crank handle toward the gear.

9. The casement operator of claim 8 wherein the detent sphere is located in the first detent when the crank handle is positioned in the retracted position and is located in the second detent when the crank handle is positioned in the extended position, the detent sphere releasably securing the crank handle in the retracted and extended positions, respectively.

10. The casement operator of claim 1 further comprising:
a knob depression in the housing, the knob depression being exposed to the storage cavity; and
a crank knob mounted to a grasping end of the crank handle, the crank knob positioned within the knob depression in the retracted position.

11. The casement operator of claim 1 wherein the housing includes a plateau, a mounting flange and a separating wall extending generally parallel to a window plane between the plateau and the mounting flange, the crank handle being in facing engagement with the plateau in the retracted position.

12. The casement operator of claim 1 wherein the crank handle is removably mounted to the gear by a handle fastener.

13. A casement operator for manipulating a window, comprising:
a housing;
a cover movably mounted to the housing;
a crank handle mounted to the housing, the crank handle pivotable between a retracted position and an extended position relative to the housing, the crank handle having a grasping end, a base end, a bore proximate the base end and a longitudinal axis;
a gear rotatably mounted to the housing having a first detent and a second detent;
a biasing member mounted within the bore; and
a securing plug mounted at least partially within the bore, the biasing member biasing the securing plug toward the gear along the longitudinal axis, the securing plug located in the first detent when the crank handle is in the retracted position and the securing plug located in the second detent when the crank handle is in the extended position to releasably secure the crank handle in the retracted and extended positions, respectively.

14. The casement operator of claim 13 wherein the securing plug is comprised of a detent sphere and the biasing member is comprised of a detent spring, the detent sphere having a diameter that is smaller than a diameter of the bore.

15. The casement operator of claim 14 wherein the detent spring is comprised of a coil spring and the detent sphere is constructed of a metallic material.

16. The casement operator of claim 13 wherein the gear is comprised of a worm gear, the worm gear including a gear end and a handle end, the first and second detents comprised of arcuate-shaped cavities located proximate the handle end of the worm gear.

17. The casement operator of claim 13 further comprising:
a cover movably mounted to the housing, the cover movable between a closed position, at least partially covering the housing and an open position, at least partially exposing the housing.

18. The casement operator of claim 13 wherein the housing includes a slot that receives the crank handle in the retracted position.

19. The casement operator of claim 13 wherein the bore is comprised of a blind bore having a closed end and a mouth, the biasing member located adjacent the closed end and biasing the securing plug one of toward and out of the mouth, the securing plug being in contact with one of the first detent, the second detent and a transition surface of the gear in an assembled configuration.

20. The casement operator of claim 13 wherein the crank handle is pivotably mounted to the gear on a handle axis, the crank handle removably mounted to the gear by a screw.
